(19) United States
(12) Patent Application Publication
(10) Pub. No.: US 2010/0248603 A1
(43) Pub. Date: Sep. 30, 2010

(54) Retrofit Fume Hood Drive Assembly

(76) Inventors: Eugene DeCastro, Jamestown, NY (US); Jared Lowe, Lakwood, NY (US); Eugene DeCastro, Jamestown, NY (US); Jeffrey Christie, Mayvilk, NY (US)

Correspondence Address: THE BILICKI LAW FIRM, PC, 1285 North Main Street, JAMESTOWN, NY, 14701, US

(21) Appl. No.: 12/415,191

(22) Filed: Mar. 31, 2009

(51) Int. Cl. B08B 15/02; B23P 19/04

(52) U.S. Cl. 454/56; 29/700

(57) ABSTRACT

A fume hood having a retrofit drive assembly includes an elongated lifting piece, such as a toothed rack, which attaches to a fume hood sash at connection point that minimizes stress on the sash. The retrofit drive assembly also includes a drive motor driven rotary engagement member, such as pinion, for opening and closing the sash. This arrangement allows for easy field retrofit, and requires limited intrusion from behind the upper regions of the existing fume hood.

### BRIEF DESCRIPTION OF THE DRAWINGS

FIG. 1a is a front view of a fume hood incorporating a sash and a rack and pinion drive system.

FIG. 1b is a front view of the fume hood of FIG. 1 with the sash in an open position.

FIG. 2a is a side view of the fume hood sash and drive system with the fume hood frame removed.

FIG. 2b is a side view of the fume hood sash and drive system with the sash in an open position.

FIG. 2c is an enlarged view of the drive system of FIG. 2.

FIG. 3a is a front view of the fume hood sash and drive system with the fume hood frame removed.

FIG. 3b is a front view of an alternate embodiment of the fume hood sash and drive system with the fume hood frame removed.

FIG. 4a is a front view of an alternate embodiment of the fume hood drive system.

FIG. 4b is a front view of the fume hood drive system of FIG. 4a with the sash open.

FIG. 5a is an exploded view of the fume hood sash and rack connection point.

FIG. 5b is a perspective view of the fume hood sash and rack connection point.

FIG. 5c is an enlarged side view of the fume hood sash and rack connection point of FIG. 5b.

FIG. 6a is an exploded view of the fume hood sash and an alternate rack connection.

FIG. 6b is a perspective view of the fume hood sash and an alternate rack connection.

FIG. 6c is an enlarged side view of the fume hood sash and alternate rack connection of FIG. 6b.

FIG. 7a is an exploded view of a frameless fume hood sash and rack connection.

FIG. 7b is a perspective view of a frameless fume hood sash and rack connection.

FIG. 7c is an enlarged side view of the frameless fume hood sash and rack connection of FIG. 7b.

FIG. 8a is an exploded view of an alternate embodiment of a frameless fume hood sash and rack connection.

FIG. 8b is a perspective view of the frameless fume hood sash and rack connection of FIG. 8a.

FIG. 8c is an enlarged side view of the frameless fume hood sash and rack connection of FIG. 8b.

FIG. 9a is a perspective view of a fume hood sash, counterweight and drive assembly.

FIG. 9b is an enlarged side view of the rack connection for the fume hood counterweight of FIG. 9a.

FIG. 10a is a front view of an alternate coupling arrangement of the drive assembly.

FIG. 10b is an enlarged perspective view of the rack and pinion of FIG. 10a.

FIG. 10c is an enlarged perspective view of the rack and pinion of FIGS. 10a and 10b.

FIG. 11 is a front view of an alternate fume hood drive assembly having two rack and pinion systems.

### DETAILED DESCRIPTION OF THE DRAWINGS

For the purpose of promoting an understanding of the embodiments described herein, reference will be made to embodiments of a fume hood as illustrated by the following drawings. It will nevertheless be understood that no limitations of the scope of the embodiments are thereby intended by such alterations as (I) changing the geometry or any element of the embodiments, (II) the placement of the various components, or (III) the quantity of each component. It is contemplated that such alterations fall within the spirit and scope of the embodiments described herein. With particular reference to the drawings, it should be understand that like numerals in different figures refer to the same elements of the various embodiments.

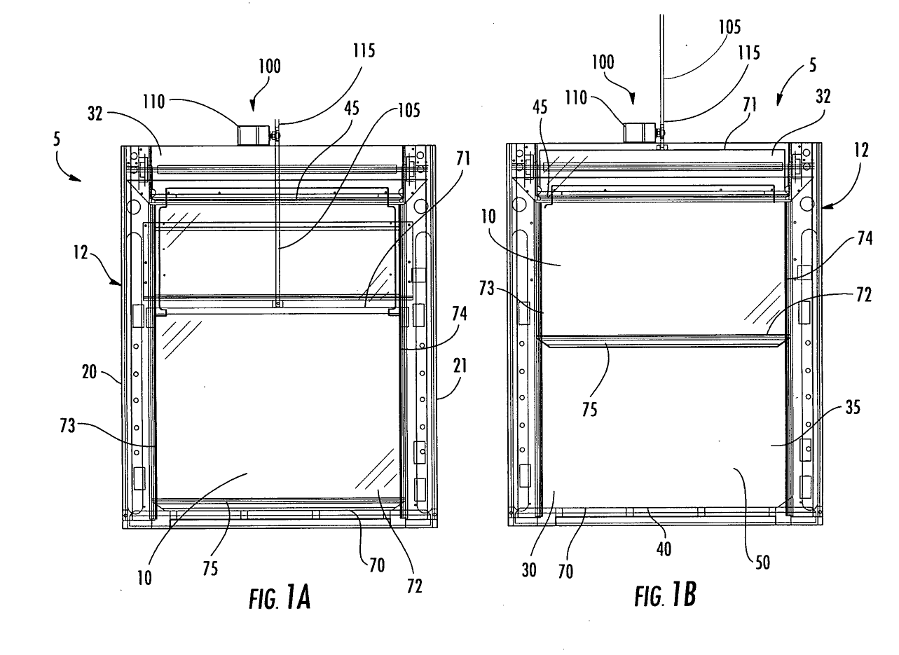

FIGS. 1a and 1b show front views of an exemplary fume hood 5. Fume hood 5 is shown in FIG. 1a with movable sash member 10 in an open position. Fume hood 10 includes a frame 12 having first and second side walls 20, 21, a back wall 30, and a front wall 32 having an access opening 35 formed therein with a work surface 40. Walls 20, 21, and 30 and work surface 40, along with a top wall 45, define work area 50. Access opening 35 allows a user to access work area 50 and work surface 40. Movable sash member 10 vertically translates along access opening 35 and provides access to work area 50 and work surface 40 when in the raised position, as shown in FIG. 1b. When in the closed position, as shown in FIG. 1a, movable sash member 10 abuts sill 70 and restricts access to work area 50 and work surface 40. Sash 10 also includes top end 71, bottom end 72, side ends 73 and 74, as well as handle 75 for assisting a user in raising and lowering sash 10. Sash 10 may be formed of metal, glass or any other suitable material.

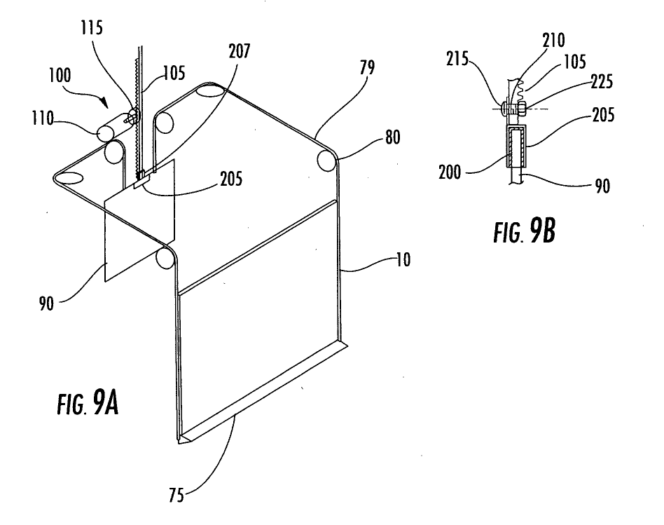

Fume hood 5 includes an existing drive mechanism, such as cables 79 and pulleys 80 and counterweight 90 (as shown in FIG. 9a) for allowing sash 10 to be opened and closed. The existing drive mechanism may also be a chain and sprocket assembly. In order to provide more control over the open and closed positions of sash 10, a motorized, retrofit drive assembly 100 is provided. Retrofit drive assembly 100 can be easily attached to an existing fume hood 5 in order to provide a more stable, controlled mechanism for raising and lowering sash 10. The retrofit drive assembly 100 may be coupled to a mechanism that causes sash 10 to automatically open and close when a user approaches or leaves the area surrounding fume hood 5. An automatic sash opening and closing mechanism that may be used with retrofit drive mechanism 100 is disclosed in “Automatic sash safety mechanism,” co-pending application Ser. No. 11/241327, which is herein incorporated by reference.

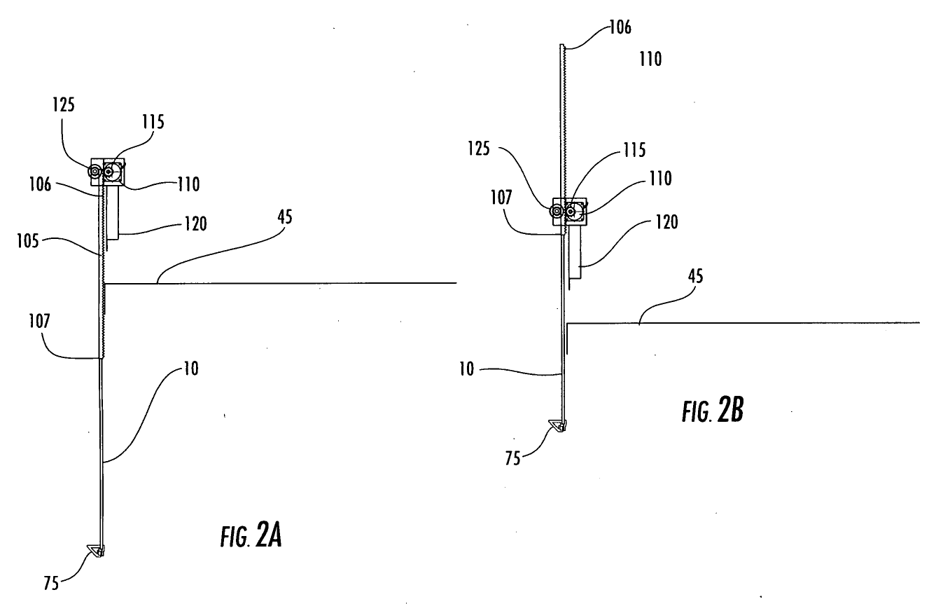

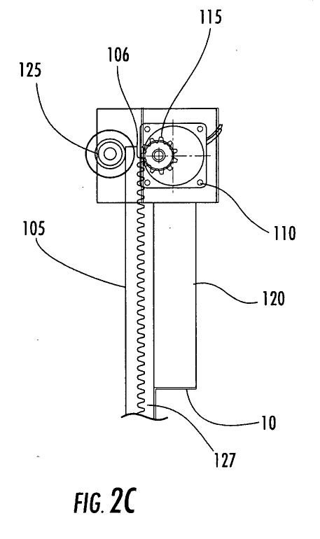

With reference to FIGS. 2a and 2b, retrofit drive assembly includes an elongated lifting piece, such as toothed rack 105, having a top end 106 and a bottom end 107, which is attached to sash 10 at connection point and a drive motor 110 driven rotary engagement member, such as pinion 115, for opening and closing sash 10. This arrangement allows for easy field retrofit, and requires limited intrusion from behind the upper regions of the existing fume hood 5. Once the upper airfoil (not shown) of fume hood 5 is removed, easy access to sash 10 is obtained for retrofitting drive assembly 100. Gear motor 110 is an Oriental motor model 3IK15GN-AW 1/50 hp induction motor (reversible), 120 VAC-60 Hz at 15 watts, 1450 rpm, coupled to a Oriental Motor gear box Model 3GN25KA with a gear ration of 25:1, shaft output 72 rpm. Rack 105 is a 20 pitch steel with a face width of ⅜″. Pinion 115 is a 20 pitch 24 tooth steel gear with a pitch diameter of 1.200″. These components result in a linear motion of sash 10 at approximately 4″/sec. Gear motor 110 is mounted on a bracket 120 which is connected to top of fume hood frame (not shown), which is spaced apart from top wall 45 of fume hood 5. In FIG. 2a, sash 10 is shown in the closed position and FIG. 2b illustrates sash in the full open position.

FIG. 2c is an enlarged view of rack 105, gear motor 110, and pinion 115. Gear motor 110 is mounted on bracket 120 to the hood top frame. Rack 105 is a toothed rod that is positioned between pinion 110 and an idler ball bearing 125 to prevent rack 105 from moving laterally during operation. More specifically, idler 125 prevents rack 105 from moving out of engagement with the pinion gear 115. As shown in FIG. 2c, there is a space 127 between bracket 120 and rack 105. When gear motor 110 causes pinion 115 to rotate clockwise, rack 105 will raise sash 10 to an open position, as shown in FIG. 2b. When pinion 115 rotates counterclockwise sash 10 will close, as shown in FIG. 2a.

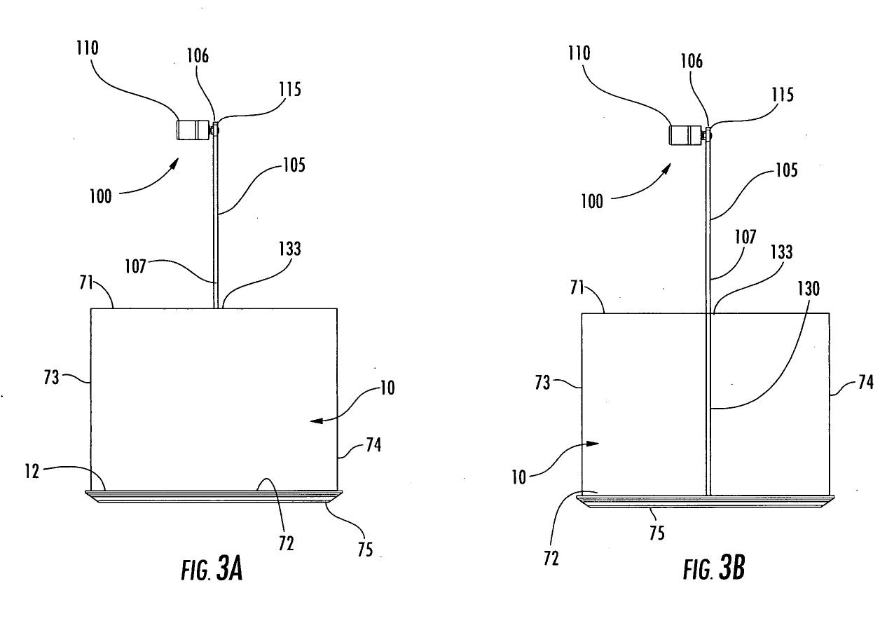

As shown in FIGS. 3a and 3b, bottom end 107 of rack 105 may be attached to top end 71 of sash 10 or may include a rod 130 attached to bottom end 72 of sash for additional structural support. Rod 130 may be formed of metal and may be attached to rack 105 at center point 133. In addition, rod 130 provides support to sash 10 along its surface down to handle 75.

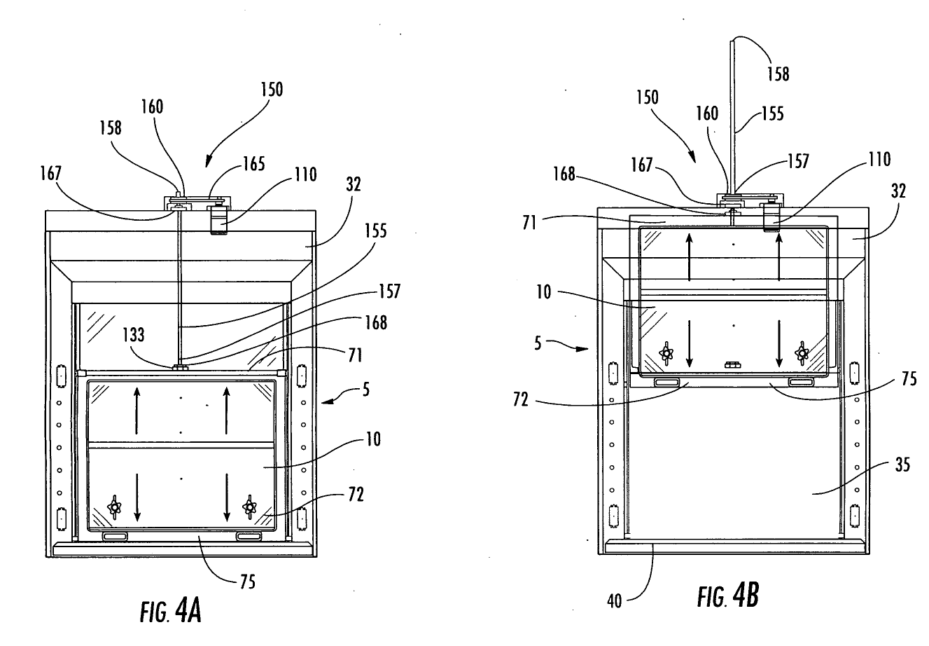

An additional embodiment of a retrofit drive assembly is indicated at 150 in FIGS. 4a and 4b. In this embodiment retrofit drive assembly 150 takes the form of a lead screw mechanism. Retrofit drive assembly 150 includes a threaded rod, or lead screw, 155 having a bottom end 157 and a top end 158. Lead screw 155 is threadably attached to a nut 160, such as a ball nut, which is operably coupled to chain and sprocket assembly 165. Further, lead screw 155 is coupled to gear motor 110 through a chain and sprocket assembly 165. Gear motor 110 causes movement of the chain and sprocket assembly, which, in turn, causes nut 160 to rotate and raise or lower sash 10. An upper antifriction bearing 167 bearing 168 connects lead screw 155 to top end 71 of sash 10 to provide for movement of lead screw 155. Retrofit drive assembly 150 is easily installed in an existing fume hood to provide greater stability and control over the movement of sash 10.

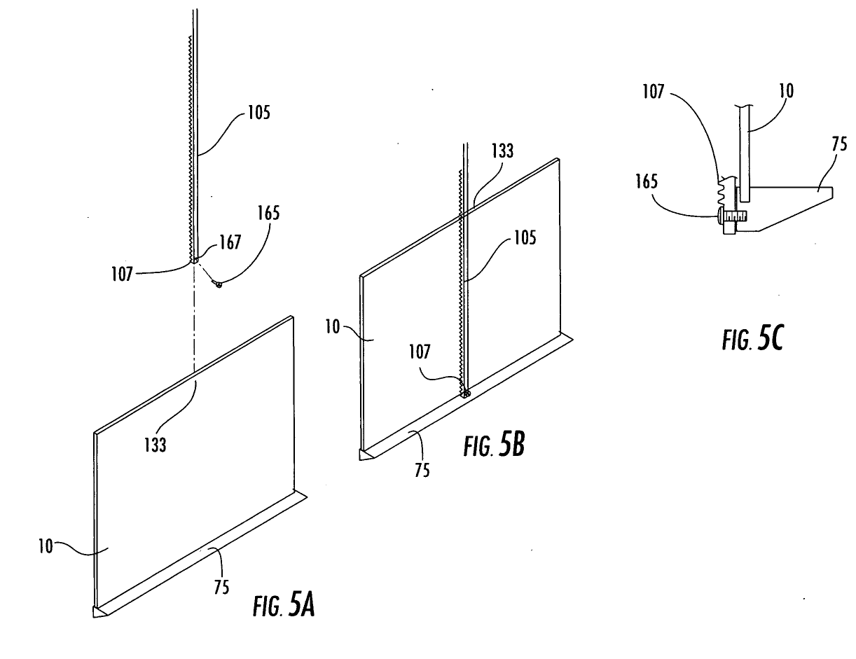

FIGS. 5a-5c illustrate an embodiment of a connection between rack 105 and sash 10. In the embodiment shown, sash 10 does not include a frame. An elongated rack 105, having a top end (not labeled) and a bottom end 107, is coupled to handle 75 of sash 10. A rear side of sash handle 75 includes an aperture (not shown) for receiving a fastener 165, such as a screw. Fastener 165 passes through a hole 167 in bottom end 107 of elongated rack 105 and the aperture in sash handle 75, thereby fastening rack 105 to sash 10. This arrangement allows rack 105 to swivel about fastener 165 as sash 10 is opened and closed to prevent binding.

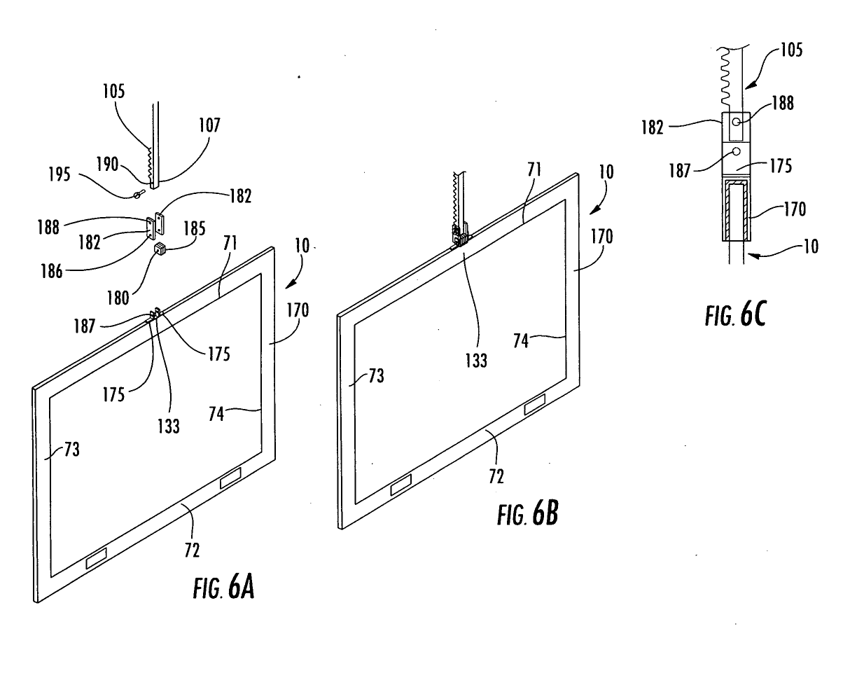

FIGS. 6a-6c disclose an alternative connection between rack 105 and sash 10. As shown, sash 10 includes a frame 170 surrounding top end 71, bottom end 72, and side ends 73 and 74 of sash 10. Mounting brackets 175, which may be formed of steel, are attached to frame 170 at top end 71 of sash 10. A lower block 180 and a pair of side blocks 182 are positioned between mounting brackets 175 to prevent binding of rack 105 as it is being raised and lowered by pinion 115. Blocks 180 and 182 may be formed of neoprene. Lower block 180 is positioned between frame 170 and bottom end 107 of rack 105. In addition, lower block 180 is surrounded on each end by side blocks 182. A hole 185 is formed in lower block 180 so that lower block 180 may be joined to side blocks 182 through holes 186 formed therein. In an assembled position, hole 185 of lower block 180, holes 186 of side blocks 182, and apertures 187 of brackets 175 align such that a fastener (not shown) may be inserted to join lower block 180, side blocks 182 and brackets 175. The pair of side blocks 182 also includes a second pair of holes 188 formed in an upper end thereof. Lower end 107 of rack 105, which is positioned between side blocks 182, includes an aperture 190. When assembled, holes 188 align with aperture 190 such that a fastener 195 can be inserted therein to join rack 105 to sash 10. This connection between rack 105 and sash 10 allows two axes of freedom to prevent binding of rack 105.

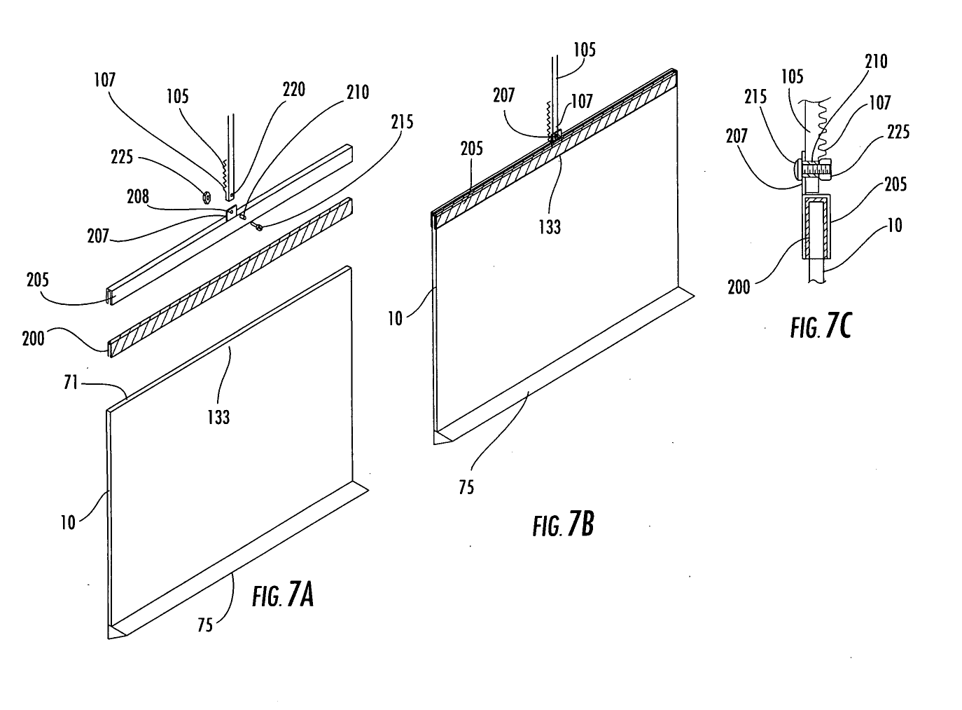

An alternate embodiment of the connection between rack 105 and sash 10 is shown in FIGS. 7a-7c. In this embodiment sash 10 is formed of tempered glass. A double sided adhesive channel 200 is placed over the top edge 71 of sash 10. A rigid channel 205, which may be formed of stainless steel, is then positioned over adhesive channel 200. The adhesive of channel 200 bonds sash 10 to rigid channel 205 and provides a secure connection for attachment of rack 105. Rigid channel 205 includes an upstanding tab 207 having an aperture 208 formed therein. A neoprene sleeve 210 is placed over a screw 215, which is inserted into aperture 208 of tab 207 and a hole 220 formed in a front portion of bottom end 107 of rack 105. Sleeve 210 has a durometer of Shore A 40 and the wall thickness of sleeve 210 is sufficient to allow motion of the sash front to rear without creating a binding force on rack 105. This also allows sash 10 to pivot about aperture 208 as sash 10 cocks during opening and closing. A fastener nut 225 is attached to screw 215 to hold rack 105 and tab 207 together. As rack 105 is moved up and down by gear motor 110, sash 10 may move side to side within the guides (not shown) of sash 10 creating high stress on the sash glass. Neoprene sleeve 210 allows motion between rack 105 and sash 10 to reduce stress and possibly failure.

Fume hood sashes 10 are typically made of tempered glass and are located in guide rails (not shown) located on the right and left sides of fume hood structure 5. To promote lower opening and closing forces, a gap is required between sash 10 and the guide rails. Due to the gap, as sash 10 moves vertically up and down, sash 10 will also move in a plane perpendicular to sash 10. That is, the gap allows for sash 10 to cock and to move slightly front to back within the guide rails. This motion, if not compensated for, will result in sufficient forces to cause rack 105 to bind with pinion 115 as sash 10 is raised to the full open position. To compensate for this misalignment, rack 105 may be connected to sash 10 at center portion 133 thereof.

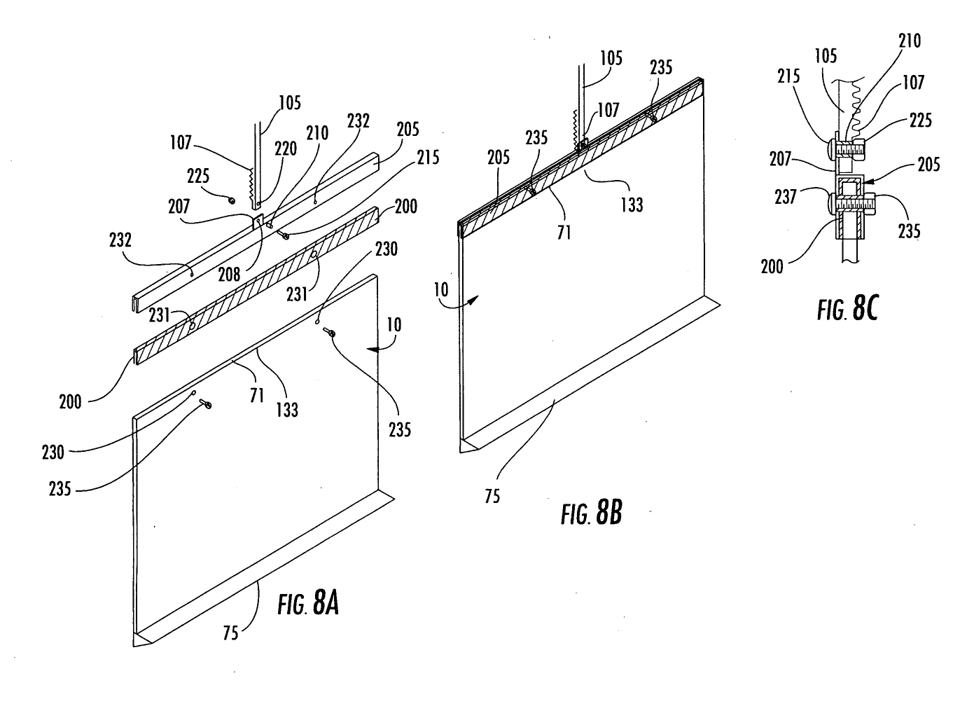

FIGS. 8a-8c illustrate a further embodiment, wherein rack 105 is attached to a sash 10 formed of laminated glass. As discussed in connection with FIGS. 7a-7c, a double sided adhesive channel 200 is placed over the top edge 71 of sash 10. A rigid channel 205, which may be formed of stainless steel, is then positioned over adhesive channel 200. The adhesive of channel 200 bonds sash 10 to rigid channel 205 and provides a secure connection for attachment of rack 105. Rigid channel 205 includes an upstanding tab 207 having an aperture 208 formed therein. A neoprene sleeve 210 is placed over a screw 215, which is inserted into aperture 208 of tab 207 and a hole 220 formed in a front portion of bottom end 107 of rack 105. A fastener nut 225 is attached to screw 215 to hold rack 105 and tab 208 together. In the embodiment shown in FIGS. 8a-8c, holes 230, 231, and 232 are predrilled into top edge 71 of sash 10, adhesive channel 200 and rigid channel 205, respectively, to allow fasteners 235 to be inserted to add additional support to sash 10. A nut 237 is attached to screw 235 to hold top edge 71 of sash 10, adhesive channel 200 and rigid channel 205 together. Additional holes may be added to top edge 71 of sash 10, adhesive channel 200 and rigid channel 205, as required, depending on the width of sash 10.

FIGS. 9a and 9b illustrate another embodiment of retrofit drive assembly 100. As shown, an existing fume hood may include cables 79 and pulleys 80 that connect sash 10 to counterweight 90. In the embodiment shown, retrofit drive system 100 including gear motor 110, pinion 115 and rack 105, has been moved toward the back of fume hood 5 and connected to counterweight 90. Rack 105 is connected to counterweight 90 in a manner similar to the connection discussed with reference to FIGS. 7a-7c. In particular, a double sided adhesive channel 200 is placed over a top edge of counterweight 90. A rigid channel 205, which may be formed of stainless steel, is then positioned over adhesive channel 200. The adhesive of channel 200 bonds counterweight 10 to rigid channel 205 and provides a secure connection for attachment of rack 105. Rigid channel 205 includes an upstanding tab 207 having an aperture 208 formed therein. A neoprene sleeve (not shown) may be placed over a screw 215, which is inserted into an aperture of tab 207 and a hole formed in a front portion of bottom end 107 of rack 105. A fastener nut 225 is attached to screw 215 to hold rack 105 and tab 207 together.

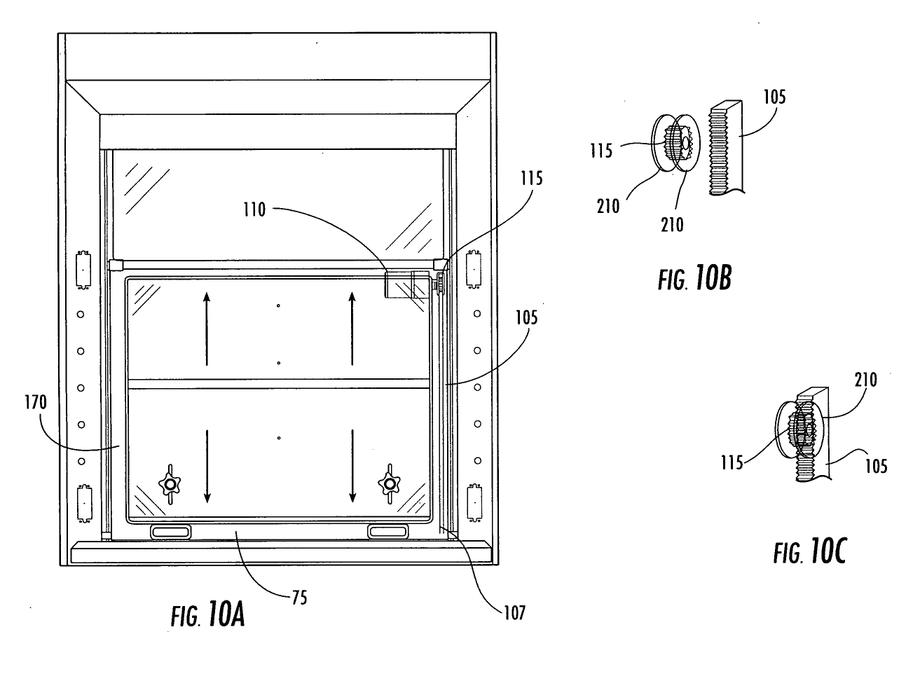

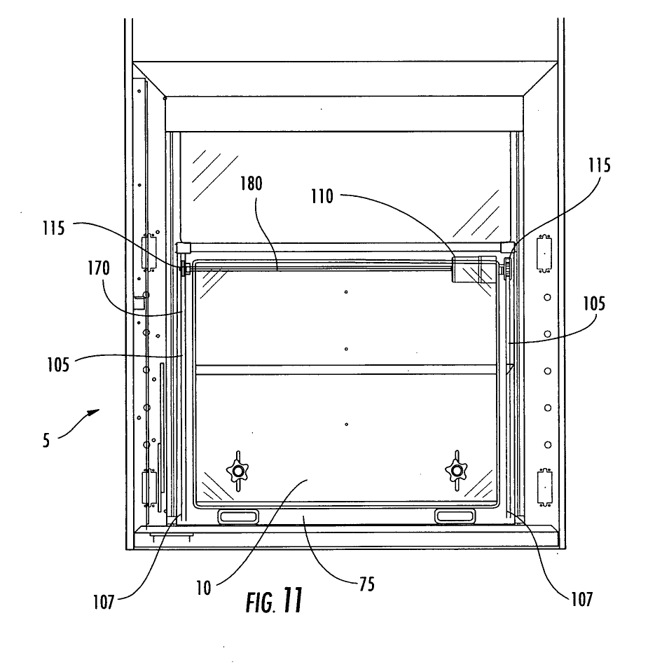

FIGS. 10a and 10b illustrate an additional embodiment of retrofit drive assembly 100. If fume hood 5 is positioned in a room where there is insufficient clearance above fume hood 5 for rack 105 to extend, rack 105 may be mounted on an inside or outside surface of sash frame 170 as shown in FIG. 10a. Washers 210 are welded to pinion 115 and act as guides as they move over rack 105, preventing sash 10 from cocking as sash 10 is opened or closed. An idler (not shown) may be mounted frame of hood 5 such that it contacts rack 105 at a side opposite pinion 115. The idler provides the pressure required to keep the pinion gear 115 in engagement with rack 105.

In the embodiment shown in FIG. 11 two racks 105 are provided. One rack 105 is attached to each side of sash frame 170. Gear motor 110 is connected to a second pinion 115 by shaft 180. Second pinion 115 engages rack 105 on the left side of frame 170. This configuration lifts sash 10 from both sides of the sash and prevents the sash form cocking as the sash is opened or closed.

While several embodiments of the retrofit drive assembly have been shown and described, it is to be understood that the retrofit drive assembly is not limited thereto, but is susceptible to numerous changes and modifications as known to a person skilled in the art, and it is intended that the interpretation not be limited to the details shown and described herein, but rather cover all such changes and modifications as are obvious to one of ordinary skill in the art.

What is claimed is:

1. A fume hood comprising:
a frame having a top surface, two opposing side walls, a back wall and a front face with an access opening into a working chamber;
a movable sash member having of a top end and a bottom end and two opposing side ends and a center portion therebetween, said sash member being movably attached to said front face;
an existing mechanism coupled to said movable sash member for raising and lowering said sash member over said access opening;
a retrofit drive assembly attached to said fume hood, said retrofit drive assembly comprising:
an elongated lifting piece attached to said sash;
a rotary engagment member for engaging said elongated lifting piece; and
a drive motor operably connected to said rotary engagement member for causing rotation of said rotary engagment member and vertical movement of said elongated lifting piece and said sash.

2. The fume hood according to claim 1 wherein said elongated lifting piece is a toothed rack and said rotary engagment member is a pinion.

3. The fume hood according to claim 2, wherein said rack is attached to said center portion of said sash such as to reduce lateral stresses on said sash.

4. The fume hood according to claim 2, wherein said toothed pinion being positioned on said top surface of said fume hood.

5. The fume hood according to claim 2, wherein said sash is formed of glass and includes a handle on said bottom end and said rack is attached to said sash at a center portion of said handle.

6. The fume hood according to claim 2, wherein said sash includes a frame surrounding said top end, bottom end, and side ends of said sash and wherein said rack is fastened to said top end of said frame by brackets and resilient pieces, said resilient pieces being positioned between said brackets and said frame.

7. The fume hood according to claim 2, wherein said sash is formed of glass and said rack is fastened to said sash by an elongated rigid channel that fits over said top end of said sash, said rigid channel being attached to said sash by adhesive.

8. The fume hood according to claim 7, wherein said adhesive is a double sided adhesive channel positioned between said top end of said sash and said elongated rigid channel.

9. The fume hood according to claim 8, wherein said rigid channel includes an upstanding tap projecting therefrom with an aperture formed therein and said rack is attached to said tab by a fastener having a resilient sleeve.

10. The fume hood according to claim 7, wherein said rigid channel includes at least one additional aperture formed therein through which a fastener extends to attach said channel to said sash.

11. The fume hood according to claim 2, wherein said rack is attached to one of said two opposing side ends of said sash and said pinion is positioned adjacent to one of said two opposing side walls of said fume hood.

12. The fume hood according to claim 11, further comprising a second rack attached to a second one of said two opposing side ends of said sash and a second pinion adjacent to a second one of said opposing side walls of said fume hood, wherein a rod connects said pinion to said second pinion.

13. The fume hood according to claim 1, wherein said top end of said fume hood may be removed to install said retrofit drive assembly.

14. The fume hood according to claim 1, wherein said existing mechanism for raising and lowering said sash member is a cable and pulley assembly.

15. The fume hood according to claim 1, wherein said existing mechanism for raising and lowering said sash member is a chain and sprocket assembly.

16. The fume hood according to claim 1, wherein said elongated lifting piece is a threaded rod and said rotary engagment member is a chain and sprocket assembly.

17. The fume hood according to claim 16, wherein said elongated lifting piece is connected to said sash by a bearing.

18. In an existing fume hood having a frame with a top surface, two opposing side walls, a back wall and a front face with an access opening into a working chamber, a movable sash member having of a top end and a bottom end and two opposing side ends and a center point therebetween, said sash member being movably attached to said front face, a retrofit drive assembly comprising:
an elongated lifting piece attached to said sash;
a rotary engagment member for engaging said elongated lifting piece; and
a drive motor operably connected to said rotary engagment member for causing rotation of said rotary engagment member and vertical movement of said elongated lifting piece and said sash.

19. The retrofit drive assembly according to claim 18 wherein said elongated lifting piece is a toothed rack and said rotary engagment member is a pinion.

20. The retrofit drive assembly according to claim 19, wherein said rack is attached to said center portion of said sash such as to reduce lateral stresses on said sash.

21. The retrofit drive assembly according to claim 19, wherein said toothed pinion is positioned on said top surface of said fume hood.

22. The retrofit drive assembly according to claim 19, wherein said sash is formed of glass and includes a handle on said bottom end and said rack is attached to said sash at a center portion of said handle.

23. The retrofit drive assembly according to claim 19, wherein said sash includes a frame surrounding said top end, bottom end, and side ends of said sash and wherein said rack is fastened to said top end of said frame by brackets and resilient pieces, said resilient pieces being positioned between said brackets and said frame.

24. The retrofit drive assembly according to claim 19, wherein said sash is formed of glass and said rack is fastened to said sash by an elongated rigid channel that fits over said top end of said sash, said rigid channel being attached to said sash by adhesive.

25. The retrofit drive assembly according to claim 24, wherein said adhesive is a double sided adhesive channel positioned between said top end of said sash and said elongated rigid channel.

26. The retrofit drive assembly according to claim 24, wherein said rigid channel includes an upstanding tap projecting therefrom with an aperture formed therein and said rack is attached to said tab by a fastener having a resilient sleeve.

27. The retrofit drive assembly according to claim 24, wherein said rigid channel includes at least one aperture formed therein through which a fastener extends to attach said channel to said sash.

28. The retrofit drive assembly according to claim 19, wherein said rack is attached to one of said two opposing side ends of said sash and said pinion is positioned adjacent to one of said two opposing side walls of said fume hood frame.

29. The retrofit drive assembly according to claim 28, further comprising a second rack attached to a second one of said two opposing side ends of said sash and a second pinion adjacent to a second one of said opposing side walls of said fume hood, wherein a rod connects said pinion to said second pinion.

30. The retrofit drive assembly according to claim 18, wherein said top end of said fume hood may be removed to install said retrofit drive assembly.

31. The retrofit drive assembly according to claim 18, wherein said existing mechanism for raising and lowering said sash member is a cable and pulley assembly.

32. The retrofit drive assembly according to claim 18, wherein said existing mechanism for raising and lowering said sash member is a chain and sprocket assembly.

33. The fume hood according to claim 18, wherein said elongated lifting piece is a threaded rod and said rotary engagment member is a chain and sprocket assembly.

34. The fume hood according to claim 33, wherein said elongated lifting piece is connected to said sash by a bearing.

35. A method of converting an existing fume hood into a gear motor operated fume hood, wherein said existing fume hood includes a top surface, two opposing side walls, a back wall and a front face with an access opening into a working chamber, and a movable sash member having of a top end, a bottom end, two opposing side ends and a center point therebetween, said method comprising:
attaching an elongated lifting piece to said sash;
positioning a rotary engagment member within said fume hood, said rotary engagement member being adapted to engage said lifting piece; and
operably connecting a drive motor to said rotary engagment member for causing rotation of said rotary engagment member and vertical movement of said lifting piece and said sash.

36. The method according to claim 35 wherein said elongated lifting piece is a toothed rack and said rotary engagment member is a pinion.

37. The method according to claim 36, wherein said rack is attached to said center portion of said sash such as to reduce lateral stresses on said sash.

38. The method according to claim 36, wherein said toothed pinion is positioned on said top surface of said fume hood.

39. The method according to claim 36, wherein said sash is formed of glass and includes a handle on said bottom end and said rack is attached to said sash at a center portion of said handle.

40. The method according to claim 36, wherein said sash frame surrounding said top end, bottom end, and side ends of said sash and wherein said rack is fastened to said top end of said frame by brackets and resilient pieces, said resilient pieces being positioned between said brackets and said frame.

41. The method according to claim 36, wherein said sash is fastened to said sash by an elongated rigid channel that fits over said top end of said sash, said rigid channel being attached to said sash by adhesive.

42. The method according to claim 41, wherein said adhesive is a double sided adhesive channel positioned between said top end of said sash and said elongated rigid channel.

43. The method according to claim 41, wherein said rigid channel includes an upstanding tap projecting therefrom with an aperture formed therein and said rack is attached to said tab by a fastener having a resilient sleeve.

44. The method according to claim 41, wherein said rigid channel includes at least one aperture formed therein through which a fastener extends to attach said channel to said sash.

45. The method according to claim 36, wherein said rack is attached to one of said two opposing side ends of said sash and said pinion is positioned adjacent to one of said two opposing side walls of said fume hood.

46. The method according to claim 45, further comprising a second rack attached to a second one of said two opposing side ends of said sash and a second pinion adjacent to a second one of said opposing side walls of said fume hood, wherein a rod connects said pinion to said second pinion.

47. The method according to claim 35, wherein said top end of said fume hood may be removed to install said retrofit drive assembly.

48. The method according to claim 35, wherein said existing mechanism for raising and lowering said sash member is a cable and pulley assembly.

49. The method according to claim 35, wherein said existing mechanism for raising and lowering said sash member is a chain and sprocket assembly.

50. The method according to claim 35, wherein said elongated lifting piece is a threaded rod and said rotary engagment member is a chain and sprocket assembly.

51. The method according to claim 35, wherein said elongated lifting piece is connected to said sash by a bearing.
